(19) United States
(12) Patent Application Publication
(10) Pub. No.: US 2007/0150609 A1
(43) Pub. Date: Jun. 28, 2007

(54) Method and system to download and track digital material

(76) Inventors: Danielle Louise Lehrer, Sydney, New South Wales (AU); Robert Jacob Karp, Sydney, New South Wales (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/596,507

(22) PCT Filed: Dec. 17, 2004
(86) PCT No.: PCT/AU04/01775

§ 371 Date: Jun. 15, 2006

(30) Foreign Application Priority Data
Dec. 19, 2003 (AU) 2003907064
Jan. 2, 2004 (AU) 2004900010

(51) Int. Cl. G06F 15/16

(52) U.S. Cl. 709/229

(57) ABSTRACT

A method of providing a digital data item to a user, the user having registered on a server so that user information has been stored in a User Information Database, an application also having been associated with a user terminal by encoding a unique identifier of the user terminal in the application, the unique identifier also having been stored in the User Information Database, the method including the steps of: receiving a request for the digital data item from the application on the user terminal; checking the authorisation of the application to obtain the digital data item by querying the User Information Database; and if authorised, transmitting the digital data item to the user terminal.

### TECHNICAL FIELD

The present invention relates to a method and system for downloading and tracking digital material, and in particular, a means to manage downloads and the transfer of copyrighted, licensed or otherwise protected digital material, for example to prevent unauthorised duplication.

### BACKGROUND ART

“Digital material” as used herein refers to any digital or computerised data or information that may be stored and transferred between electronic devices or storage devices, such as any type of terminal as herein described.

A “Digital Data Item” (DDI) is a single particular instance of digital material. A DDI is a uniquely identifiable item of digital material.

In a networked data communications system, users have access to terminals which are capable of requesting and receiving information from local or remote information sources. In such a system a terminal may be a type of processing system, computer or computerised device, a personal computer (PC), a mobile or cellular telephone, a mobile data terminal, a portable computer, a personal digital assistant (PDA), a pager, a thin client, a T.V., a set top box or any other similar type of electronic device. The capability of the terminal to request and/or receive information or data files, eg. a DDI, can be provided by an application program, hardware, firmware, etc. A terminal may be provided with associated devices, for example a local storage device such as a hard disk drive or solid state drive or memory, a media card (for example CF or SD card), etc.

An information source can be a server(s) or any other type of suitable terminal coupled to an information storage device. The exchange of information (i.e., the request and/or receipt of information or data, such as a DDI) between the terminal and the information source, or other terminal(s), is facilitated by communication means. The communication means can be realised by physical cables, for example a metallic cable such as a telephone line, semi-conducting cables, electromagnetic signals, for example radio-frequency signals or infra-red signals, optical fibre cables, satellite links or any other such medium or combination thereof connected to a network infrastructure.

The network infrastructure can include devices such as a telephone switch, a base station, a bridge, a router, or any other such specialised component, which facilitates the connection between the terminal and the information source. Collectively, an interconnected group of terminals, communication means, infrastructure and information sources is referred to as a network. The network itself may take a variety of forms. For example, it may be a computer network, telecommunications network, data communications network, Local Area Network (LAN), Wide Area Network (WAN), wireless network, Internetwork, Intranetwork, the Internet and developments thereof, transient or temporary networks, combinations of the above or any other type of network providing for communication between computerised, electronic or digital devices. A network as referenced in this specification should be taken to include any type of terminal or other similar type of electronic device, or part thereof, which is rendered such that it is capable of communicating with at least one other terminal.

Presently, the distribution of digital material has not been limited in any formalised way. The downloading of digital material can be limited by password, or user name and password, however, once digital material is downloaded to a terminal the distribution of the digital material is usually unlimited.

Digital Rights Management (DRM) is the process whereby artificial scarcity is imposed on a Digital Data Item (DDI). DDIs can be freely copied without degradation in their quality. Some attempts at limiting the distribution of digital material have been made by consortiums of manufacturers, content providers and industry bodies.

There is a need to provide a reliable method and/or system of downloading, tracking and/or monitoring digital material to prevent the proliferation of unauthorised copies and ensure that, if desired, revenues may be collected on a per-copy basis, which can additionally enhance the scarcity (or “collectability”) of the digital material.

It would be beneficial for digital material, such as images, audio, video, ring tones, games, songs, etc., to be able to be downloaded, tracked and/or monitored regardless of how the digital material may be propagated, for example, via a network, swapping of a storage device or media card, or any other means.

This identifies a need for a method, system and/or computer readable medium of instructions which overcomes or at least ameliorates problems inherent in the prior art.

### DISCLOSURE OF INVENTION

In a broad form the present invention seeks to provide a system and/or method that is adapted to manage the secure transferring of copyrighted, licensed or otherwise protected or owned digital material, such as images, audio, video, ring tones, games, songs, etc., between terminals in such a way as to prevent unauthorised duplication or use.

The present invention seeks to provide:

a fixed, or finite, number of copies of digital material as Digital Data Items (DDIs) that can be downloaded from an information source; and

that a DDI can be transferred, but cannot be modified or duplicated. This seeks to ensure that only a finite number of copies of DDIs are ever in circulation, thus also enhancing the digital material's “collectability”.

In a further broad form the present invention seeks to limit the total number of times that a DDI may be downloaded, thereby seeking to ensure that only a finite number of copies of a particular item of digital material are in circulation. In particular forms, such a system may be offered as a paid subscription download service or as a value-adding promotional service.

The present invention also seeks to facilitate transfer (by way of moving from an originating terminal to a destination terminal) of a DDI such that ownership of or a right to use the DDI is also transferred and centrally recorded as such. Tracking of DDI ownership or licensing can occur when the DDI is transferred.

In a further broad form the present invention provides a method of offering a DDI stored on an information source to a user and tracking the DDI, the user having registered and downloaded an application to the user's terminal, the application encoding a unique identifier of the terminal, said method including the steps of:

authenticating the user;

identifying the DDI to be downloaded to the terminal using a unique serial number;

downloading the DDI to the terminal by communication between the information source and the terminal; and

whereby, the DDI can be subsequently downloaded to another terminal only if the DDI is deleted from the original terminal.

The present invention according to a further aspect seeks to provide the transfer of the DDI to another terminal by:

an original user initiating a download of the DDI from the information source;

a recipient user accepting the download from the information source to a recipient terminal;

the DDI being deleted from an original terminal;

the DDI being downloaded to the recipient terminal; and

a unique key being transmitted to the recipient terminal.

This process may be conducted using an intermediatory third-party to authorise downloads and transfers. The original user could be the recipient user transferring the DDI to another terminal.

According to yet a further broad form of the invention, there is provided a method of providing a digital data item to a user, the user having registered on a server so that user information has been stored in a User Information Database, an application also having been associated with a user terminal by encoding a unique identifier of the user terminal in the application, the unique identifier also having been stored in the User Information Database, the method including the steps of: receiving a request for the digital data item from the application on the user terminal; checking the authorisation of the application to obtain the digital data item by querying the User Information Database; and if authorised, transmitting the digital data item to the user terminal.

In various possible, but non-limiting, particular aspects of the invention: the user information and the unique identifier are also stored on the user terminal; the user information and the unique identifier are stored in a further User Information Database on the user terminal; authorisation is performed by comparing the User Information Database on the server and the further User Information Database on the user terminal; the unique identifier is a serial number, product number, manufacturing number, or the like, of the user terminal or part thereof; successful completion of transmittal of the digital data item is reported to and tracked by the server; the digital data item is allocated a unique serial number; and/or the digital data item can only be subsequently transmitted to a second user terminal by the server when the digital data item has been deleted from the user terminal.

According to yet a further broad form of the invention, there is provided a method of transferring a digital data item from an originator terminal to a recipient terminal, the method including the steps of: an originator application on the originator terminal requesting the transfer of the digital data item, the request being transmitted to a server; a recipient application on the recipient terminal accepting the request for the transfer of the digital data item, the request being transmitted from the server; deleting the digital data item from the originator terminal; and, transmitting the digital data item from the server to the recipient terminal.

In further various possible, but non-limiting, particular aspects of the invention: a unique key is also transmitted to the recipient terminal; a database associated with the server is updated to record the transfer of the digital data item; a user of the originator terminal and a user of the recipient terminal are registered in a User Information Database associated with the server; the server checks access rights of a user prior to the transfer of the digital data item; and/or the digital data item is part of a Content Library Database associated with the server.

According to still yet a further broad form of the invention, there is provided a system for providing a digital data item for use by a user, including: an application provided on a user terminal, the application storing a unique identifier of the user terminal; a User Information Database, the unique identifier also being stored in the User Information Database; and, a server adapted to check the authorisation of the application to receive the digital data item by querying the User Information Database, and to transmit the digital data item to the user terminal.

According to still yet a further broad form of the invention, there is provided a system for transferring a digital data item from an originator terminal to a recipient terminal, the system including: an originator application provided on the originator terminal for requesting the transfer of the digital data item, the request being transmitted to a server; a recipient application provided on the recipient terminal for receiving the request for the transfer of the digital data item, the request being transmitted from the server; the server adapted to effect deletion of the digital data item from the originator terminal and transmit the digital data item from the server to the recipient terminal.

According to still yet a further broad form of the invention, there is provided a processing system for facilitating the transfer of a digital data item from an originator terminal to a recipient terminal, the processing system including: a first processing system associated with at least one User Information Database; a second processing system associated with at least one Content Library Database; the first processing system adapted to receive a request for the transfer of the digital data item from an originator application provided on an originator terminal; the second processing system adapted to effect deletion of the digital data item from the originator terminal and transmit the digital data item to a recipient application provided on the recipient terminal.

In a further broad form the present invention also provides a system and/or a computer readable medium of instructions for realising or embodying the aforementioned methods.

In a further broad form, the present invention also provides a service which allows management and tracking of DDIs and the recipients of the DDIs. These are the users of the service.

According to yet a further broad form of the invention, there is provided a user information database for facilitating the tracking and publication of DDIs for sale, barter or transfer of DDIs.

According to still yet a further broad form of the invention, there is provided a processing system for valuing a DDI and confessing a ranking to each user of the service based on the user's DDI ownership portfolio at any given time.

### BRIEF DESCRIPTION OF FIGURES

The present invention should become apparent from the following description, which is given by way of example only, of a preferred but non-limiting embodiment thereof, described in connection with the accompanying figures.

FIG. 1 illustrates an example functional block diagram of a processing system embodiment of the present invention;

FIG. 2 illustrates an example series of steps for effecting download of a DDI to a user terminal;

FIG. 3 illustrates an example handover protocol for transferring a DDI;

FIG. 4 illustrates an example particular embodiment of the server-side system architecture;

FIG. 5 illustrates an example particular embodiment of the user or client-side system architecture.

### MODES FOR CARRYING OUT THE INVENTION

The following modes are described in order to provide a more precise understanding of the subject matter of the present invention.

In the figures, incorporated to illustrate the features of the present invention, like reference numerals are used to identify like parts throughout the figures.

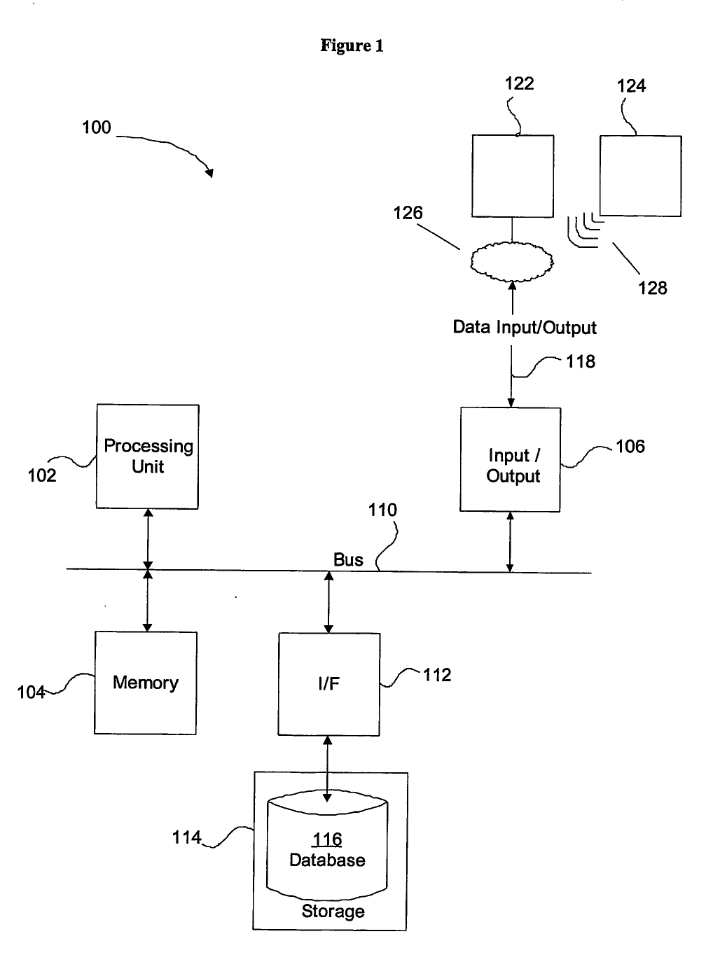

A particular embodiment of the present invention can be realised using a processing system, an example of which is shown in FIG. 1. In particular, the processing system 100 generally includes at least a processor or processing unit 102, a memory 104, an input/output device 106, coupled together via a bus or collection of buses 110. An interface 112 can also be provided for coupling the processing system 100 to a storage device 114 which houses a database 116. The memory 104 can be any form of memory device, for example, volatile or non-volatile memory, solid state storage devices, magnetic devices, etc. The input/output device 106 receives data input 118 and can include, for example, a network connection, etc. The output device 106 produces data output 118. The storage device 114 can be any form of storage means, for example, volatile or non-volatile memory, solid state storage devices, magnetic devices, etc.

Input/output device 106 communicates using data input/output 118 with terminals or devices 122 and/or 124 via communication networks or communication protocols 126 and/or 128 (for example the Internet or a wireless network). As an illustrative, but non-limiting, example terminal 122 may be a remote Internet connected PC in communication with the processing system 100 embodied as a server, and terminal 124 may be a mobile telephone in wireless communication 128 with server system 100.

In use, the processing system 100 is adapted to allow DDI's to be stored in and/or retrieved from the database 116. The processor 102 receives instructions via the input/output device 106, for example a download request, and if authenticated, the system 100 can transmit to the terminal 122 or 124 a requested DDI via the input/output device 106. It should be appreciated that the processing system 100 may be any form of processing system, computer terminal, server, specialised hardware, or the like.

The following examples provide a more detailed discussion of embodiments of the present invention. The examples are intended to be merely illustrative and not limiting to the scope of the present invention.

In a particular form the present embodiment seeks to ensure that only a finite number of copies of a DDI are downloaded. The method utilised to ensure this includes the following steps.
1. An application, preferably being a Collector Applet, is installed on a user terminal. This may occur by a service provider transmitting the Collector Applet to the user terminal 122 or 124. This step only needs to be performed the first time the user uses the service. Alternatively the Collector Applet may be preinstalled on the user terminal.
2. A user, or equally a subscriber, is registered in order to utilise the service. Registration requires the user to provide identification details to the service provider, for example by submission of information to a server. The subscription details are saved in a User Information Database (UID) and are also sent to the server. This registration step only needs to be completed the first time the user or subscriber uses the Collector Applet. By locating the UID on both the user terminal and the server the service can then perform a digest-based authentication process.
3. The Collector Applet is “bound” to a user terminal. Each user terminal should have its own Collector Applet. The Collector Applet encodes a unique identifier of the terminal so that the Collector Applet does not work on any other terminal. The unique identifier of the terminal may be a serial number (eg. MSISDN, IMSI, IMEI, etc.), or any other accessible identifier, number, code, etc., that uniquely identifies the terminal or part thereof. The unique identifier of the terminal is also saved into the UID on both the user terminal and the server. This step only needs to be performed the first time the user utilises the service.
4. The user is then authenticated. Using a secure mechanism such as SSL (Secure Socket Layer) the user is identified to the server offering the service. When connecting to the server, the server can present a nonce. Both the Collector Applet and the server can calculate a cryptographic one-way hash over both the contents of the UID and the nonce. If they match, the user is authenticated.
5. The DDI is then identified. The DDI to be downloaded is identified via a unique serial number that is provided by the user.
6. The DDI is then downloaded to the user terminal. Preferably, it should be ensured that the DDI has successfully been downloaded to the user terminal, not that the download was merely initiated.

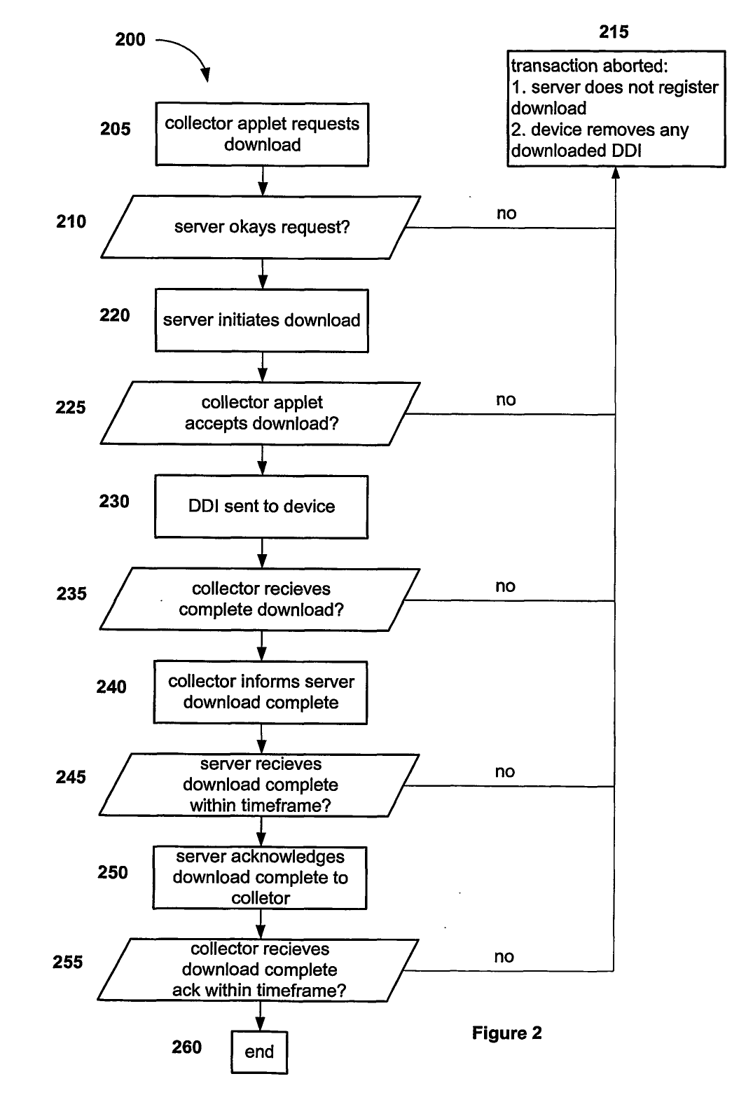

Referring to FIG. 2, a method 200 of ensuring successful downloading to the terminal is illustrated. At step 205 the Collector Applet requests downloading of the DDI from the server. At step 210 the server is required to authenticate the request. If the request is denied the transaction is aborted at step 215. If the transaction is aborted the server does not register the download and the user terminal or device removes any downloaded or partially downloaded DDI. If the server authenticates the request at step 210 the server initiates the download of the DDI at step 220. At step 225 the Collector Applet checks whether it should accept the download of the DDI. If the Collector Applet does not accept the download of the DDI the transaction is aborted at step 215. If the Collector Applet does accept the download of the DDI, then the DDI is sent from the server to the user terminal as illustrated at step 230. The Collector Applet checks whether the DDI has been completely downloaded at step 235, and if not the transaction is aborted at step 215. If the complete downloaded DDI is received then the Collector Applet informs the server of completion of the download of the DDI at step 240. The server checks at step 245 whether the download was completed within a preset timeframe, and if not the transaction is aborted at step 215. If the download was completed within the acceptable timeframe, at step 245, then the server acknowledges the completed download to the Collector Applet at step 250. The Collector Applet then verifies itself whether it received the complete downloaded DDI within the timeframe at step 255, which if positive ends the process at step 260, or if not, the transaction is aborted.

Transferring the downloaded digital material embodied as a DDI is now discussed. The present embodiment seeks to allow the transfer of protected material such that a recipient receives an originator's copy of the digital material and the originator's copy of the digital material is deleted.

This is achieved by a client-server-client operation. That is, the two Collector Applets (a first Collector Applet residing on an originator terminal and a second Collector Applet residing on a recipient terminal) do not communicate directly with each other but rather send messages/information via the server(s). This can be achieved using any client-server network including WAP; SMS; TCP/IP (for example over GPRS or 3G); wireless or wireline Ethernet; or any other type of network.

Once the transfer is initiated the net effect is that the DDI is copied from the originator terminal to the recipient terminal and it is ensured that the DDI is: (A) successfully transferred to the recipient terminal; and (B) deleted from the originator terminal.

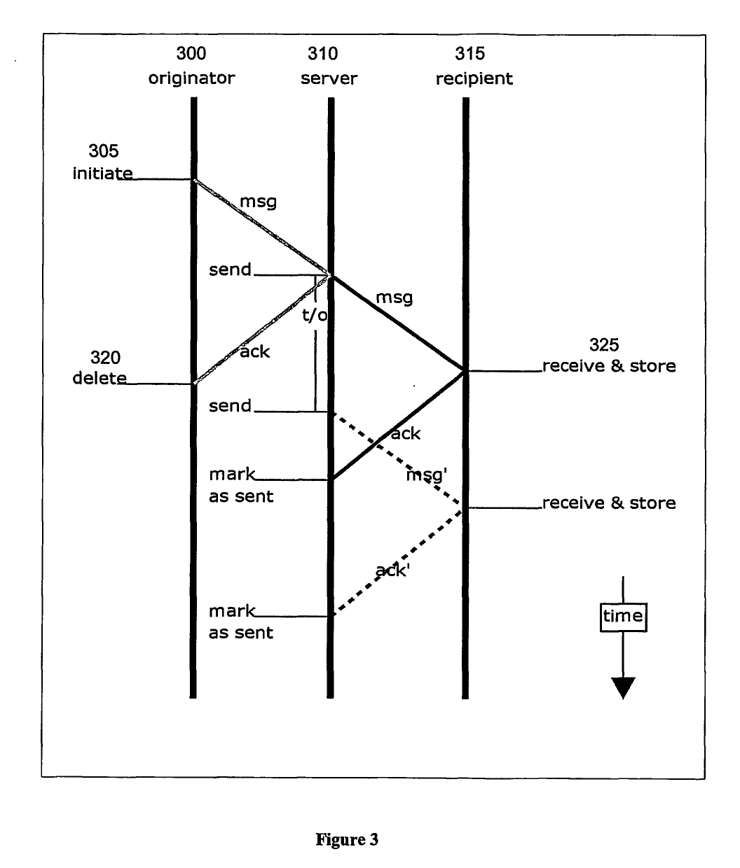

In a particular embodiment, this can be achieved using the process or protocol illustrated in FIG. 3. Referring to FIG. 3, the originator 300 initiates a transfer 305 to server 310. The recipient 315 accepts the download of the DDI from the server 310. In FIG. 3, the terms ‘msg’, ‘ack’and ‘t/o’ refer to ‘message’, ‘acknowledge’ and ‘time/out’ respectively. The DDI is then deleted 320 from the originator terminal, and the DDI is transmitted 325 to the recipient terminal. A unique key is also transmitted to the recipient terminal. At the server 310, records can be dated to identify that a particular DDI has been deleted from the originator terminal and sent to the recipient terminal. If required, timing of these transactions can be monitored to attempt to identify invalid or incomplete transactions.

The present invention can allow tracking of the pathway of each DDI. This is possible as a user is required to register with the server in order to participate in the service. The user may also only transfer a DDI to another user using a server offering the service. This allows the server (or servers) to gather and maintain information about: the popularity and collectable nature of each DDI; the profile of users participating in the DDI transfer service for different segments and types of DDIs; and the buying and transferring habits of users.

Tracking of each DDI can also be associated with billing or accounting software to collect and/or distribute revenues or payments appropriate to each DDI. Users may use the service by fixed subscription fees, charges per DDI or set of DDIs, or any other suitable payment method. In a particular embodiment, digital material content providers may or may not be charged a subscription fee, and it is possible that the service could distribute royalty fees to content providers.

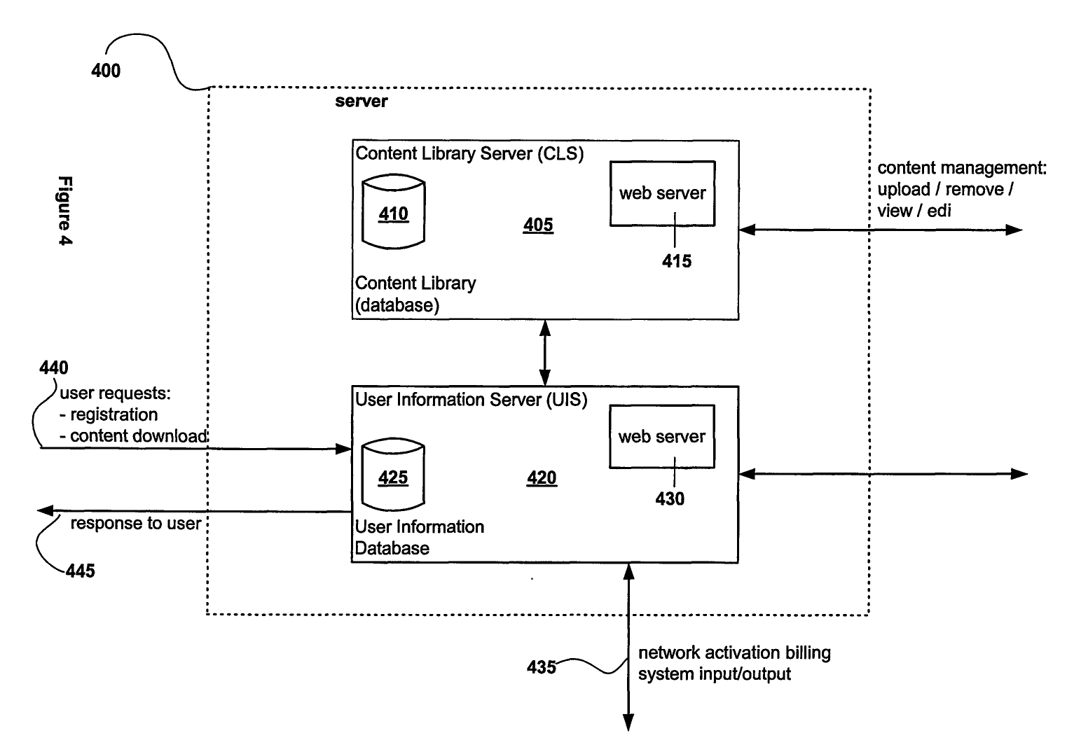

Illustrated in FIG. 4 is a particular server-side system architecture suitable for use in the present embodiment. Server(s) 400 includes Content Library Server (CLS) 405 housing Content Library Database (CLD) 410 and web server 415. User Information Server (UIS) 420 can house User Information Database (UID) 425 and web server 430. Web server 415 is responsible for digital material content management, such as uploading, removing, viewing and editing of content. Web server 430 is responsible for management of user information. The User Information Server 420 is also preferably in communication 435 with a billing system and network activation system. User requests for registration and content download 440 are received by User Information Server 420 which also provides a response 445 to the user terminal as per the previously mentioned methods.

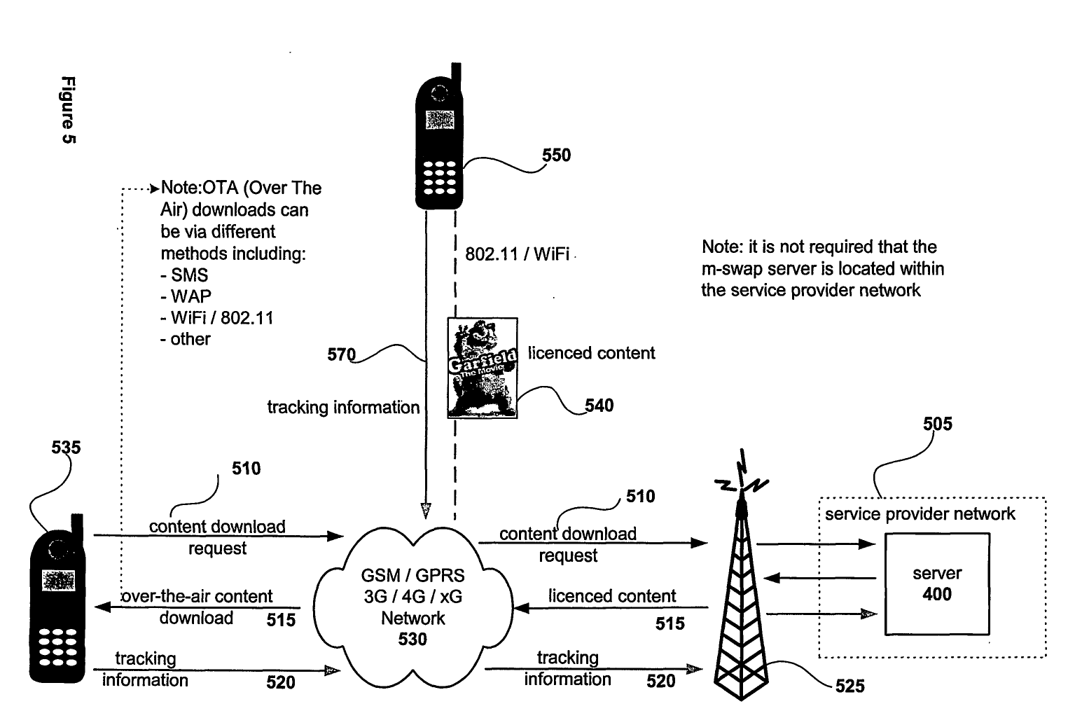

FIG. 5 illustrates the user or client-side system architecture according to a particular embodiment of the present invention. The server 400 (or servers) are part of a service provider network 505, although this is not an essential feature. Communication of content download requests 510, licensed content transmission 515 and tracking information 520 can occur via base station 525 in the case of a GSM/GPRS network 530. User terminal 535 (in this case a mobile telephone) initiates content download requests 510, receives content downloads 515 and offers tracking information 520 to the server 400. Content downloads 515 in the embodiment illustrated can be via different methods including: SMS, WAP, WiFi/802.11, or any other suitable means. Licensed or copyrighted content 540 can be transferred with another user terminal 550 via any suitable means, such as infra-red , bluetooth, or WiFi, etc. Tracking information 570 is transmitted/received from terminals 550 to/from the server 400 via network 530.

Operation of the Collector Applet:

In a particular embodiment, the Collector Applet initialises and checks that a user (i.e. subscriber) has valid continued access to the service. The Collector Applet can then display the collection(s) of digital material that is available. A user can add, remove and/or transfer DDIs. The Collector Applet contacts the server 400 to verify that transfers and additions are allowed, and, if appropriate, commence download of a DDI.

As used herein, a token may be composed of one of many serial numbers and/or unique identifiers.

Users may also “interact” with a DDI. The form of the interaction is DDI specific. As some illustrative examples: for a mobile telephone ringtone, a user may interact with the DDI itself to set the ringtone as active on the mobile telephone; for a picture or graphic, the DDI may be to set as the wallpaper or screen background; or for a game, the user may select to play the game. The nature of the DDI specific option is encoded within the DDI itself.

Operation of the Server-Side:

In a particular embodiment, the server-side of the present system has a number of functions, including, but not necessarily limited to: content uploading, reviewing and indexing; billing and user services.

Responses:

The client terminal and server both know about a number of responses and requests. These include:

Registration Requests: are sent by the Collector Applet to notify the server of its presence. This allows the server to authorise (or not) the Collector Applet. Valid responses are:

‘valid’: returned if the Collector Applet is authorised.

‘invalid’: returned if there is a problem with any part of the unique token, authorisation details, the hash, or any other reason.

Transfer Requests: are sent by the Collector Applet when the user wishes to give/transfer a DDI to another user. The server can respond with the following:

‘invalid’: returned if the any of the authorisation parameters are deemed incorrect.

‘not-allowed’: returned if the DDI can not be transferred.

‘valid-direct’: returned if the DDI can be transferred directly to the other user.

‘valid’: returned if the DDI can be transferred and is to be performed by the server.

Download Requests: the Collector Applet sends this when a user requests a specific DDI, or has received a DDI via a transfer. The server can respond with the following:

‘invalid’: returned if the any of the authorisation parameters are deemed incorrect.

‘valid-but-gone’: the DDI token is valid but the DDI is no longer downloadable.

‘valid’: the DDI is valid and the server may either send the DDI itself or location details to the Collector Applet as to where to obtain the DDI.

Thus, there has been provided in accordance with the present invention, a system and method allowing the downloading, monitoring and/or tracking of digital material.

Although the foregoing description of a preferred embodiment of the invention requires a central server to be involved in the process, it is possible to allow arbitrary users/subscribers to transfer DDIs amongst themselves.

The invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made by one of ordinary skill in the art without departing from the scope of the present invention.

1. A method of providing a digital data item to a user, the user having registered on a server so that user information has been stored in a User Information Database, an application also having been associated with a user terminal by encoding a unique identifier of the user terminal in the application, the unique identifier also having been stored in the User Information Database, the method including the steps of: receiving a request for the digital data item from the application on the user terminal; checking the authorisation of the application to obtain the digital data item by querying the User Information Database; and if authorised, transmitting the digital data item to the user terminal.

2. The method as claimed in claim 1, wherein the user information and the unique identifier are also stored on the user terminal.

3. The method as claimed in claim 2, wherein the user information and the unique identifier are stored in a further User Information Database on the user terminal.

4. The method as claimed in claim 3, wherein authorisation is performed by comparing the User Information Database on the server and the further User Information Database on the user terminal.

5. The method as claimed in claim 1, wherein the unique identifier is a serial number of the user terminal or part thereof.

6. The method as claimed in claim 1, wherein successful completion of transmittal of the digital data item is reported to and tracked by the server.

7. The method as claimed in claim 1, wherein the digital data item is allocated a unique serial number.

8. The method as claimed in claim 1, wherein the digital data item can only be subsequently transmitted to a second user terminal by the server once the digital data item has been deleted from the user terminal.

9. A method of transferring a digital data item from an originator terminal to a recipient terminal, the method including the steps of: an originator application on the originator terminal requesting the transfer of the digital data item, the request being transmitted to a server; a recipient application on the recipient terminal accepting the request for the transfer of the digital data item, the request being transmitted from the server; deleting the digital data item from the originator terminal; and, transmitting the digital data item from the server to the recipient terminal.

10. The method as claimed in claim 9, wherein a unique key is also transmitted to the recipient terminal.

11. The method as claimed in claim 9, wherein a database associated with the server is updated to record the transfer of the digital data item.

12. The method as claimed in claim 9, wherein a user of the originator terminal and a user of the recipient terminal are registered in a User Information Database associated with the server.

13. The method as claimed in claim 9, wherein the server checks access rights of a user prior to the transfer of the digital data item.

14. The method as claimed in claim 9, wherein the digital data item is part of a Content Library Database associated with the server.

15. A system for providing a digital data item for use by a user, including: an application provided on a user terminal, the application storing a unique identifier of the user terminal; a User Information Database, the unique identifier also being stored in the User Information Database; and, a server adapted to check the authorisation of the application to receive the digital data item by querying the User Information Database, and to transmit the digital data item to the user terminal.

16. A system for transferring a digital data item from an originator terminal to a recipient terminal, the system including: an originator application provided on the originator terminal for requesting the transfer of the digital data item, the request being transmitted to a server; a recipient application provided on the recipient terminal for receiving the request for the transfer of the digital data item, the request being transmitted from the server; the server adapted to effect deletion of the digital data item from the originator terminal and transmit the digital data item from the server to the recipient terminal.

17. A processing system for facilitating the transfer of a digital data item from an originator terminal to a recipient terminal, the processing system including: a first processing system associated with at least one User Information Database; a second processing system associated with at least one Content Library Database; the first processing system adapted to receive a request for the transfer of the digital data item from an originator application provided on an originator terminal; the second processing system adapted to effect deletion of the digital data item from the originator terminal and transmit the digital data item to a recipient application provided on the recipient terminal.

18. The processing system as claimed in claim 17, wherein the first processing system is a user information server.

19. The processing system as claimed in claim 17, wherein the second processing system is a content library server.

20. The processing system as claimed in claim 17, wherein tracking information is stored in the first or second processing system.

21. The processing system as claimed in claim 17, wherein the originator application stores a unique identifier of the originator terminal.

22. The processing system as claimed in claim 17, wherein the recipient application stores a unique identifier of the recipient terminal.

23. The processing system as claimed in claim 21, wherein the unique identifier is also stored in the User Information Database.

24. The processing system as claimed in claim 17 further adapted to verify the transfer request by querying the User Information Database prior to transmitting the digital data item to the recipient terminal.

25. The processing system as claimed in claim 17, wherein the originator terminal and the recipient terminal are each provided with a further User Information Database.

26. The processing system as claimed in claim 17, further adapted to confer a ranking to a user based on the user's DDI ownership portfolio at a given time.

27. The processing system as claimed in claim 17, wherein the User Information Database facilitates the tracking and publication of DDIs for sale, barter or transfer.
